(19) United States
(12) Patent Application Publication
(10) Pub. No.: US 2013/0241284 A1
(43) Pub. Date: Sep. 19, 2013

(54) Load Distribution System and Power Management System and Method

(71) Applicant: TRANSISTOR DEVICES, INC. . D/B/A TDI POWER, Hackettstown, NJ (US)

(72) Inventors: John Santini, Columbia, NJ (US); Lazar Rozenblat, Brooklyn, NY (US); Ronald DeLuca, Islip, NY (US); Gary Mulcahy, Flanders, NJ (US)

(73) Assignee: Transistor Devices, Inc. . d/b/a TDI Power, Hackettstown, NJ (US)

(21) Appl. No.: 13/788,431

(22) Filed: Mar. 7, 2013

Related U.S. Application Data
(60) Provisional application No. 61/610,775, filed on Mar. 14, 2012.
(60) Provisional application No. 61/611,204, filed on Mar. 15, 2012.
(60) Provisional application No. 61/611,713, filed on Mar. 16, 2012.
(60) Provisional application No. 61/616,078, filed on Mar. 27, 2012.

(51) Int. Cl. H02J 4/00

(52) U.S. Cl. CPC H02J 4/00
USPC 307/31

(57) ABSTRACT

A power management system for distributed power management from a power source to a plurality of power units, using a monitor bus to monitor total power usage on a branch to which the power unit is assigned, allowing power to be delivered if it won't result in a maximum current draw from the power source being exceeded, and denying access if it would. Each power unit adds a signal to the monitor bus proportional to the current it is drawing from the power source.

### REFERENCE TO RELATED APPLICATIONS

This application claims one or more inventions which were disclosed in the following U.S. Provisional Applications: No. 61/610,775, filed Mar. 14, 2012, entitled “Load Distribution System and Power Management System and Method”; No. 61/611,204, filed Mar. 15, 2012, entitled “Power Management System using Power Supplies Adapted To Use Tri-State Power Management Signals”; No. 61/611,713, filed Mar. 16, 2012, entitled “Load Distribution System and Power Management System and Method”; and No. 61/616,078, filed Mar. 27, 2012, entitled, “Power Management System using Power Supplies Adapted To Use Tri-State Power Management Signals”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of power supplies. More particularly, the invention pertains to a system and method for power management and load distribution.

2. Description of Related Art

Electronic systems are often deployed where a plurality of end user nodes are serviced via a power system where there is not enough power available to allow simultaneous operation of all nodes.

In an aircraft system, the power source is typically 115V 400 Hz AC generated by one or more engine-powered generators, or supplied by an Auxiliary Power Unit (APU) or battery-powered inverter when the aircraft is on the ground. The available power from the power source is limited by the total output of the generator(s) or APU or inverter, and by demands on the power source by the aircraft's own systems.

Increasingly there is a demand for passengers to be able to hook up their own electronic devices in flight, such as laptop computers or media players, etc. These devices usually expect a voltage of 120-240VAC at 50-60 Hz, so power converter units are required to provide power at an appropriate voltage and frequency to a power outlet into which the passenger can plug his or her device. Airlines would like to provide under-seat outlets to allow all of the passengers to plug such devices in for use, but the total current drawn if all passengers in a large jet were to simultaneously plug in laptop computers would exceed the total available for such use.

In some present systems outlets which are not currently in use are disabled when a total measured power drawn by enabled outlets exceeds a certain threshold. This threshold is typically set to 200 watts or so below the maximum desired load limit on the branch circuit so that the last user will not cause an overload. This “buffer” power is usually wasted capacity, since a typical user may only need half that amount or less. Once that limit is reached, subsequent users are simply denied any power at all, even though they may have paid “full fare” for their ticket.

Various methods have been developed in the prior art to monitor delivered power and then deny service to new subscribers, or deny power to existing subscribers, effectively removing them from the network. To date, these methods are either administered from a central power distribution unit (PDU), or are set up in such a way that they are not easily adaptable or scalable to various deployment scenarios.

Legacy systems often employ a centralized power management scheme where power is monitored in a Master Control Unit (MCU) and when the MCU determines delivered power is reaching the limits of what is available for that branch, it issues a signal to all units on that branch which allows existing users to continue to receive power, but does not allow new users to receive power. This signal also provides a third state that forces all units on the branch to shut down.

This system has proven to be an impediment to passenger/customer satisfaction in that significant portions of passengers may be denied power during a flight.

### SUMMARY OF THE INVENTION

The power management system of the invention allows precise power control and easy adaptability for distributed power management from a power source to multiple users served by a plurality of power units, where there are limitations on the amount of power available to the power units from the power source. Each power unit in the system uses a monitor bus to monitor total power usage on a branch to which the power unit is assigned, allowing power to be delivered if it won't result in the branch current being exceeded, and denying access if it would.

Each power unit adds a signal to the monitor bus proportional to the current it is drawing from the power source.

In a first embodiment, the signal added by the power units is an analog current and there is a resistor terminating the monitor bus at the power distribution point or the end of the branch (or elsewhere), which creates a voltage which determines the allowable branch current. The total current draw for all of the power units on the branch is measured by measuring the voltage on the monitor bus.

In an alternate embodiment, a pulse train having a repetition rate proportional to current is imposed on the monitor bus by each power unit instead of a current, and the power units determine total current by the signal frequency (number of pulses per second) on the monitor bus.

When a potential user plugs into the outlet on a power unit, the power unit recognizes this fact, and if the signal on the monitor bus is below a predetermined amount which represents a total draw below maximum, the inverter turns on. It stays on for a short time and the actual current draw of the power unit is measured and a proportional signal is added to the monitor bus. Assuming the signal on the monitor bus does not rise above the maximum the user continues to receive power. If the power unit is drawing too much current to maintain the total branch current below the maximum, one or more of the power units on the branch turn off, preventing an overload. All other existing users continue to receive uninterrupted AC power.

The system is adaptable for implementation in legacy systems that employ Master Control Units which utilize tri-state signals to manage load power.

### BRIEF DESCRIPTION OF THE DRAWING

FIG. 1 shows a block diagram of the power management system.

FIG. 2 shows a block diagram of a prior art “Legacy” aircraft power system.

FIG. 3 shows a block diagram of the power management system adapted work with a prior art “Legacy” aircraft power system.

FIGS. 4 to 6 show a detail of several embodiments of the head end connector from FIG. 3, for use with differing tri-state power systems.

FIG. 7 shows a detail of one of the power units of the system from FIG. 1.

FIG. 8 shows a block diagram corresponding to FIG. 1, for a second embodiment of the power management system using pulse frequency signalling.

FIG. 9 shows a detail corresponding to FIG. 7, for the second embodiment of the power management system.

FIG. 10 shows a signal diagram of the operation of the second embodiment of the power management system.

### DETAILED DESCRIPTION OF THE INVENTION

The system will be described herein in terms of power system for a large aircraft such as an airliner, where the limited power available from the aircraft's power system will need to be allocated to outlets used by passengers to power laptop computers and the like, but it will be understood that the system is equally applicable to other applications where a limited power resource needs to be distributed among a plurality of varying loads.

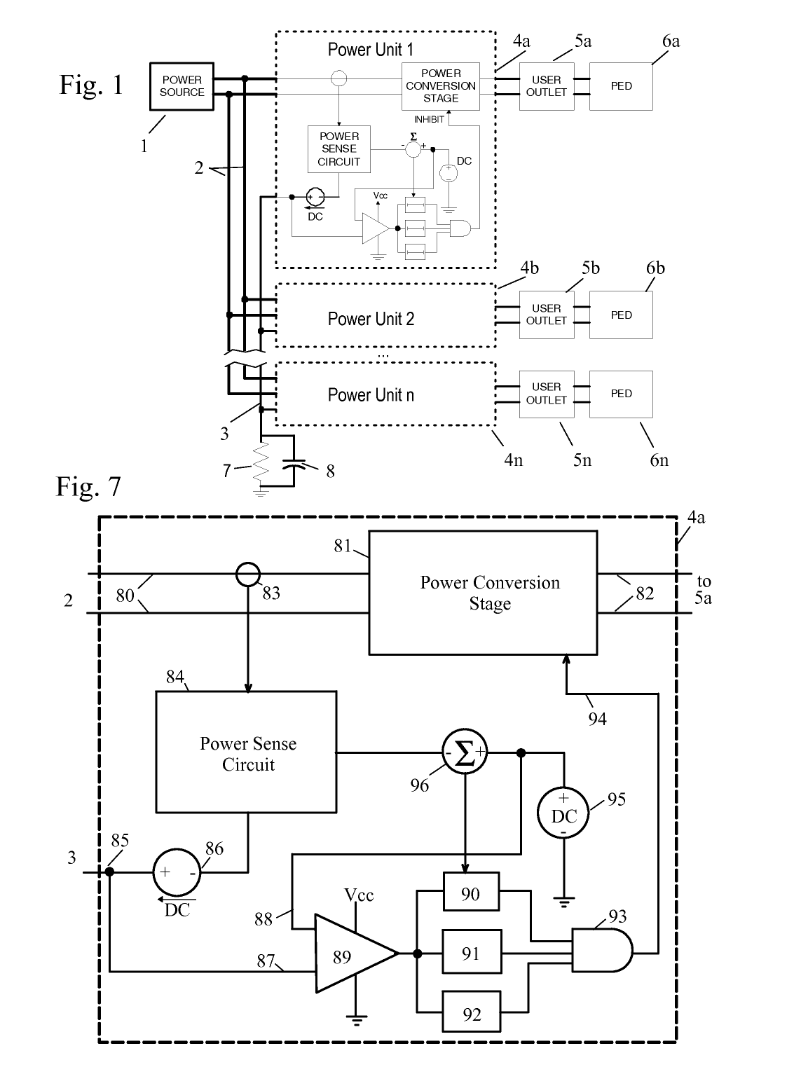

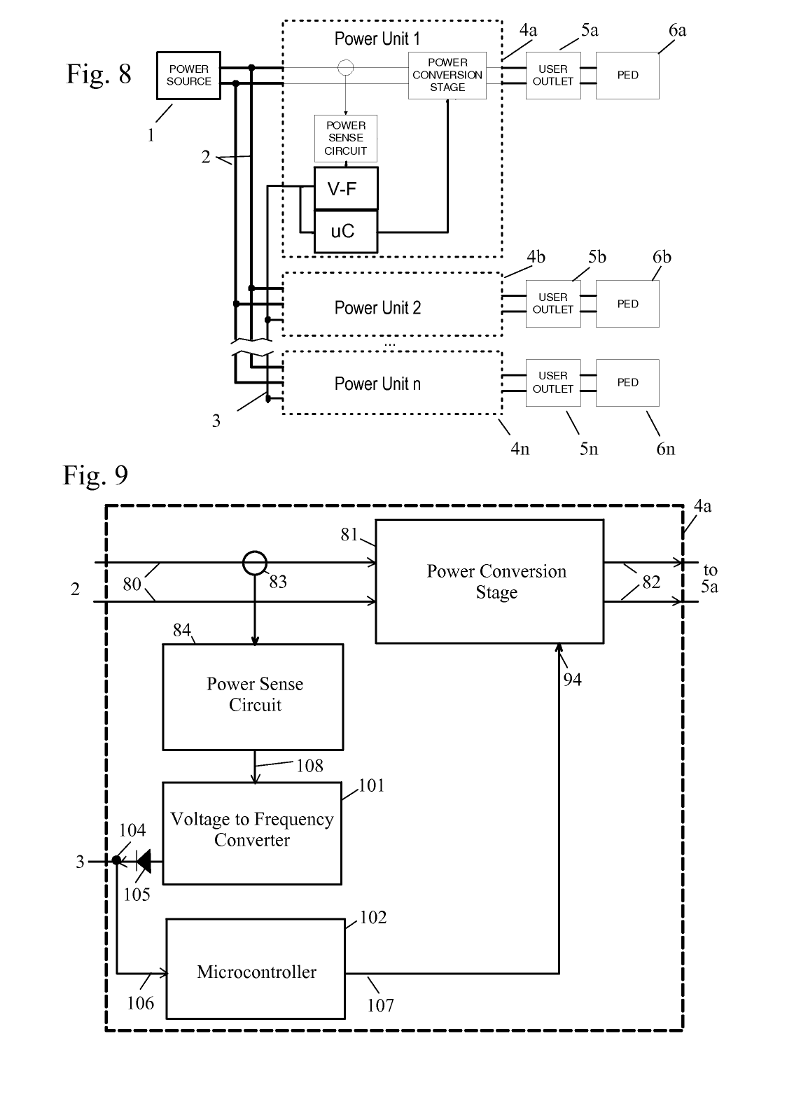

Referring to the block diagram of FIGS. 1 and 8, the load distribution system and power management method of the invention is designed to manage power distribution from a power source 1 on a branch power bus 2 to a varying number of user devices 6a-6n, each of which will want to draw a differing amount of power from its associated power outlet 5a-5n. The power bus 2 will typically be one of a plurality of branch circuits powered by the power source 1, each being protected by a fuse or circuit breaker (not shown) which sets a maximum current draw from the bus 2, but for the purposes of simplification it is sufficient to view the bus 2 as representing the total available output of the power source 1.

As noted before, the power distribution bus 2 in an aircraft is typically powered at 115VAC 400 Hz, and under-seat power outlets 5a-5n need to supply 120VAC or 240VAC at 60 Hz or 50 Hz, respectively. Therefore, each power outlet 5a-5n is provided with a power unit 4a-4n, which operates to convert the power from the power bus 2 to whatever voltage and frequency are needed at the outlet 5a-5n.

Each of the power units 4a-4n on the branch power bus 2 is connected to a single-wire branch monitor bus 3, and adds a signal to the monitor bus 3 which is proportional to the current the power unit 4a-4n is drawing from the power bus 2. The system will be described below in terms of two embodiments which vary by the nature of this signal—in the first embodiment, the signal is a DC current, and in the second embodiment the signal is a pulse train.

### Embodiment 1

### DC Current Monitor Bus Control

In this embodiment, each power unit 4a-4n adds a current to this monitor bus 3 proportional to the current it is drawing from the power bus 2. In this embodiment the monitor bus 3 is grounded through a reference resistor 7 at one point. This point could be at one end of the branch, or in a master control unit which supplies the power to the branch, or in one of the power units 4a-4n, or anywhere else on the branch as desired. The reference resistor 7 thus serves as a simple, system level threshold determination device. As current is added to the monitor bus 3 by the power units 4a-4n, a voltage drop is generated by the reference resistor 7 which is proportional to the total current being drawn from power bus 2 by all of the power units 4a-4n. If desired for noise decoupling, a capacitor 8 can be provided in parallel with resistor 7 as shown in FIG. 1.

FIG. 7 shows a detail of a representative single power unit 4a from FIG. 1. It should be noted that while this example is shown and described in terms of discrete electronic components or integrated circuits, one skilled in the art would recognize that some or all of the functions could be implemented in software running on a processor chip within the teachings of the invention.

The power unit 4a has a power conversion stage 81, which takes electrical power on its input 80 which is connected to power bus 2 (say 115VAC at 400 Hz), and converts it to a different voltage and/or frequency (say, 120VAC 60 Hz) at an output 82 which connects to outlet 5a. The power conversion stage 81 can be shut off by a signal on INHIBIT line 94.

The current in the power conversion stage 81 is measured by a sensor 83, which is input to power sense circuit 84. The example shows sensor 83 sensing current in the input 80 to power conversion stage 81, so that the sensor 83 directly reads current drawn from the power bus 2. It will be understood that the current sensing could also be done on the output 82 of the power conversion stage within the teachings of the invention, although since the output 82 might be at a different voltage, some adjustments might have to be made so that the method correctly controls the current demand on the power bus 2.

Power sense circuit 84 has an output to a control input of a controlled DC current source 86, which adds a controlled current to a lead 85 which is connected to monitor bus 3. As explained further below, the current added by current source 86 is controlled by power sense circuit 84 to be proportional to the current drawn by power conversion stage 81 through input 80 from power bus 2.

The voltage on monitor bus 3 is input through lead 85, and connects to one input 87 of comparator 89. The other input 88 of comparator 89 is connected to a reference voltage 95. The output of comparator 89 is connected to several timing circuits—in this example shown as timing circuits 90, 91 and 92, although it will be understood that more or fewer circuits may be used as desired. The reason for having multiple timing circuits is to enable the various timing and randomization methods described in the operational discussion below. A current signal from power sense circuit 84 is subtracted from the reference voltage from source 95 in summing junction 96 and the result inputs into timing circuit 90. The outputs of timing circuits 90, 91 and 92 are input into OR-gate 93, so that if any of the timers 90-92 are timed out, the output of OR-gate 93 raises the INHIBIT signal 94, as noted above.

If the power monitor bus voltage as measured by comparator 89 reaches the above reference 95, the first internal timing circuit 90 initiates and sets a certain short time delay inversely proportional to the current consumed by that unit as measured by its sensing circuit (for example 10 to 50 ms). If during this time delay the voltage did not drop below maximum allowable limit, the INHIBIT line 94 causes this unit to go into a timeout mode, where its output 82 remains inhibited for a predetermined or randomized amount of time set by the second timing circuit 91, for example, one minute.

As an example, assume a 10 ampere (A) branch current limit is required on power bus 2 to prevent a circuit breaker in the power source (master power unit) from tripping. The power units 4a-4n add a current of 1 milliamp (mA) to the monitor bus 3 per ampere of current draw on power bus 2. Resistor 7 in this example is 250 ohms. By Ohm's Law, E=IR, then, each milliamp of current on monitor bus 3 results in a voltage of 0.25 volts (V) across resistor 7. Therefore, when the total current draw of all of the power units 4a-4n on power bus 2 is the breaker-limited maximum of 10 A, the current on monitor bus 3 would be 10 mA, and the voltage across the resistor 7 would be 2.5V.

This could be 10 users at 1 A each, or 20 users at 0.5 A each, etc. Any number of subscribers at any potential load will be summed, and the total current draw on power bus 2 is available for each power unit 4a-4n to measure by measuring the voltage on the monitor bus 3.

Since the only way to determine what a potential subscriber will draw in his or her device 6a-6n is to allow them to go through their power-up sequence, each power unit 2 preferably has a start-up sequence pre-programmed into it. When a potential user plugs a device 6a into the outlet 5a, for example, power unit 4a recognizes this fact, and measures the present voltage on the monitor bus 3. If the voltage on the monitor bus 3 is already at the maximum 2.5V, this means that there is no excess capacity, and the power unit 4a does not supply power to outlet 5a.

Preferably, a predetermined “headroom” amount will be determined based on typical use which represents how much below the maximum 2.5V the voltage needs to be before the power unit 4a will decide there is sufficient additional capacity available to try powering outlet 5a. If the typical load is 0.5 A, this amount might be set, for example, to 0.15V to allow a little extra headroom.

For the purposes of this example, let us say that at the time the user plugs in device 6a, the monitor bus 3 voltage is 2.1V. This is more than 0.15V less than 2.5V, so the power unit 4a turns on. It stays on for a short time (predetermined, but dependent on the trip characteristics of the branch circuit breaker), and the actual current draw of the device 6a from power bus 2 is monitored by proportionally adding current to monitor bus 3 as explained above. For this example, assume that the device draws 1 ampere, which means that power unit 4a adds 1 mA to monitor bus 3. The voltage on the monitor bus 3 increases by 0.25V, to 2.35V. Since the total current on the power bus 2 remains less than 10 amperes (as shown by there being less than 2.5V on the monitor bus 3), the user continues to receive power.

Let us suppose at this point that a user plugs another device 6n into outlet 5n on power unit 4n. Power unit 4n checks the monitor bus 3, and sees that the voltage is 2.35V, which is still the predetermined amount 0.15V below the 2.5V maximum. So, outlet 5n is powered and device 6n begins to draw 2 amperes of current from power bus 2. Power unit 4n adds a current of 2 mA to monitor bus 3, which raises the voltage by 0.50V, from 2.35V to 2.85V. This exceeds the 2.5V monitor bus limit, and power unit 4n turns off the power to outlet 5n, preventing an overload on power bus 2. All existing users continue to receive uninterrupted AC power.

It should be noted here that rather than power unit 4n shutting off its outlet 5n as described above, because of the timing delays discussed in detail below, in some embodiments the system could operate such that when in this example the monitor bus voltage increases to 2.85V, some other power unit (4a, say) will sense the excess voltage and react first, turning off power to its outlet 5a. With the outlet 5a unpowered, current draw from power bus 2 by power unit 4a drops to zero, and the current added to monitor bus by power unit 4a also drops to zero, reducing the monitor bus 3 voltage. If this drops the voltage below 2.5V before power unit 4n can check the monitor bus voltage and turn off outlet 5n, then the user device 6n can remain powered. If this does not bring the voltage on monitor bus 3 below 2.5V, another random unit among 4a to 4n that is still operating will turn off power to its outlet, thus preventing an overload on power bus 2.

With the outlet 5n unpowered, current draw from power bus 2 by power unit 4n drops to zero, and the current added to monitor bus by power unit 4n also drops to zero, reducing the monitor bus 3 voltage back down to a safe 2.35V.

In one embodiment, power unit 4n can remain locked out as long as device 6n is plugged into outlet 5n, and can reset when the device 6n is removed, ready to try again when something else is plugged in. Preferably, however, the power unit 4n will periodically re-try powering its outlet 5n when the monitor bus 3 voltage is more than the predetermined amount less than the maximum. In that case, if someone else's device has been unplugged or is now drawing less current, or if some other power unit drops off because of the new load from 5n, the power unit 4n will be able to keep the power on its outlet 5n and the user can have power for device 6n. The time between re-tries is preferably randomized, so that multiple units will not re-try all at the same time.

The control circuit in each power unit 4a-4n continuously monitors the monitor bus 3 voltage, and preferably has an ability to temporarily restrict power flow to its outlet 5a-5n depending on the currently measured values of the voltage on monitor bus 3 based on a specific randomizing algorithm without need for any central (master) control unit. For example, if a power unit 4b detects that the monitor bus 3 voltage has reached a predetermined amount at or slightly less than the maximum 2.5V, it could switch off its outlet 5b for a determined (randomized) time, before re-trying to power its device 6b. This would lower the voltage on the monitor bus 3, giving other power units 4a-4n a chance to connect their devices 6a-6n, and power availability would thus be shared around the branch power bus 2, allowing each passenger in the aircraft to have power at least part of the time. Since most of the devices will be battery powered, the rolling dropouts of power should not be noticed as each will receive power enough of the time to keep the device powered up and the battery sufficiently charged.

Other methods of managing power when the current on the power bus 2 approaches the maximum are possible within the teachings of the invention. For example, the power unit 4a-4n that currently consumes the highest power level among all of the power units 4a-4n on a given power bus 2, can be the first one to inhibit its output if the total pre-determined current draw on power bus 2 is reached. This can be accomplished by reducing the maximum permitted voltage on monitor bus 3 in each power unit 4a-4n proportional to the power consumed by the device 6a-6n plugged into the power unit. Thus, a power unit with a high-draw device might compare the monitor bus 3 voltage to 2.3V, while a power unit with a low-draw device might use the full 2.5V maximum. If the high-draw device drops off the bus first, this will make more current available for more lower-draw devices.

The power units 4a-4n can also be configured such that a power unit which has inhibited power to its outlet 5a-5n, reconnects its output after a pre-determined period of time, after which it will remain immune from shutdown for another pre-determined period of time. This assures two things: the total power on the node always kept below the allowable limit, and every time this limit is reached, a different unit goes into inhibit mode, which provides a fair power availability to all end users.

In another implementation, a random timer can be used to delay the shutdown of the power unit. When the current limit level is reached, each unit would have a random time delay before it shut down. So the unit with the shortest time delay would turn off first, reducing the load. If the reduction was not enough, a second unit might turn off before the current is reduced sufficiently, preventing any more units from shutting down.

In still another implementation, the current limit threshold can have a small random signal imposed on it. This means that when the system is close to the current limit point, one power unit will randomly cross the limit first and shut down, lowering the total current draw. If the reduction is not enough, a second unit might shut down before the overall draw is reduced to below the limit, preventing any more units from shutting down.

If after shut down of one unit the total node power still reaches its limit, the unit with the next highest power level and accordingly the next shortest shutdown delay will be the next one to inhibit its output.

As the result of this process, the total node power is always assured to be below the maximum allowable limit. Each inhibited unit will return to active mode after a pre-determined or random time delay set by a second timing circuit (for example, one minute) and its third internal timing circuit will keep that unit “safe” for another pre-determined or random time (for example, five minutes).

If after the return of previously inhibited unit to active mode the total node power again reaches its allowable limit, this time another unit which consumes highest current which sets the shortest shutdown delay time, will be the first one to inhibit.

In another possible implementation, the reference voltage level in each unit is inversely proportional to the power consumed by the unit. As the result, when the total power consumed by all units on a given power node reaches a certain pre-determined threshold, the power monitor bus voltage will first reach the reference voltage level in the unit that consumes the lowest amount of power and which probably has an already charged PED.

In another possible implementation, the reference voltage in each unit is the same value and a non-synchronized ramp voltage is imposed on top of this reference. When the power monitoring bus reaches its allowable limit, the non-synchronized nature of the ramp will cause a randomizing effect as to which unit is shut off for power management purposes. Once a unit is inhibited, the total node power will most likely drop below the maximum limit and the remaining units will continue to operate. The unit that was shut down will be re-enabled after a predetermined or random time delay set by an internal timing circuit (for example, one minute). Once it is re-enabled, if the monitoring bus reaches its allowable limit all units on the bus will once again be subject to possible shut down, with the unit whose reference+ramp reaches the shutdown threshold first being the one that is shut off.

The unit may have a modification to be installed in high priority locations such as in first class seats, with a higher reference voltage level to assure these “priority” passengers will always get power (provided their net amount does not exceed a set limit for a given power branch), while the rest of the seats would get only remaining power when it's available.

In another possible implementation, individual power units 4a-4n can have be set with two or more different voltage limits. Power units that are for “preferred users” who will not be subject to randomized shut down would have a higher voltage limit, and a lower limit could be set for users who will be subject to randomized shut downs for power management purposes. This method allows the airline to provide preferential treatment to low power users (typically Electronic Tablet or small PED's which are the typical consumers of on board content provided by the carrier) while subjecting higher power users (typically notebook computers which do not consume on board content provided by the carrier) to randomized temporary loss of power in a power management situation.

In another possible implementation, end users can be provided with a choice of either an AC powered outlet, or a low voltage USB power port powered by the power conversion stage 81 or by a separate power conversion unit (not shown). In this implementation, the AC outlet can be subjected to power management with any of the aforementioned schemes. The USB power port can be set up to either be powered (or unpowered) in conjunction with its partnered AC outlet, or the USB port can be set to remain on, even if its associated AC outlet is subject to power management. This is another manner in which the carrier can provide preferential treatment to low power users who are the typical consumers of airline provided, on board content.

The operation of the system allows all users access to the power by periodically rotating enabled inverters. This system requires no “buffer” power level, so it typically allows an extra person to have full access to power. If additional users plug in, exceeding the branch capacity, users are dropped for a short time, as described above. In most cases a passenger whose outlet is temporarily disabled would not even notice this as they are likely operating from internal battery power during this short interval.

In another possible implementation, the “zero current” reference voltage could be a positive or negative voltage, and the voltages could be pulled high or low as units sum their currents.

### Embodiment 2

### Pulse Rate Monitor Bus Control

Referring to FIGS. 8 and 9, the basic system of this embodiment is the same as described for the first embodiment, and the common elements will not be separately described here.

FIG. 9 shows a detail of a representative single power unit 4a from FIG. 8. As with the first embodiment, the power unit 4a has a power conversion stage 81, which takes electrical power on its input 80 which is connected to power bus 2 (say 115VAC at 400 Hz), and converts it to a different voltage and/or frequency (say, 120VAC 60 Hz) at an output 82 which connects to outlet 5a. The power conversion stage 81 can be shut off by a signal on INHIBIT line 94.

The current in the power conversion stage 81 is measured by a sensor 83, which is input to power sense circuit 84. The example shows sensor 83 sensing current in the input 80 to power conversion stage 81, so that the sensor 83 directly reads current drawn from the power bus 2. It will be understood that the current sensing could also be done on the output 82 of the power conversion stage within the teachings of the invention, although since the output 82 might be at a different voltage, some adjustments might have to be made so that the method correctly controls the current demand on the power bus 2.

Power sense circuit 84 has an output 108 which provides a voltage proportional to the sensed current to a control input of a voltage-to-frequency converter 101. The voltage-to-frequency converter 101 converter produces short pulses (1 μS, as an example) and impresses these pulses on the monitor bus 3 through a diode or a tri-state driver 105. The frequency (number of pulses per second) output by the voltage-to-frequency converter 101 would be proportional to the voltage 108 with a scale factor, for example, of 1 kHz per ampere of current measured by sensor 83.

The signal on the monitor bus 3, which would comprise all of the pulses output from the pulse unit 4a and all of the other power units 4b-4n on the bus, is input 106 to a comparator in the form of a microcontroller 102, which is programmed to count the pulse frequency (total number of pulses per second). The value of the pulse frequency from the monitor bus 3 is compared to a selected reference, in this embodiment a selected frequency (or number of pulses per unit time) which represents the total maximum current draw on bus 2.

Thus, if there were ten power units 4a-4j, each drawing 1.0 ampere from bus 2, the pulse frequency on monitor bus 3 would be 10 kHz. It should be noted that there would be a small error based on how wide the pulses are and the total number of pulses measured, and there might be some pulses lost through collisions, but this can easily be approximated on a statistical basis.

When the total current on bus 2 reaches the critical point (for example, 15 Amps corresponds to 15 kHz), the microcontroller 102 detects this by counting the pulses per second on the bus, detecting the pulses exceed and raises a voltage 107 which is input to the power conversion stage 81 as INHIBIT input 94. This shuts down the converter 81 for a fixed amount of time to reduce the total bus 2 current. Since all of the microprocessors in the power units 4a-4n will be operating asynchronously, one of the power units 4a-4n (randomly) will shut down first, reducing the bus 2 current. Additional units may shut down randomly until the bus 2 current (as measured by the pulses per second on monitor bus 3) are reduced below the limit.

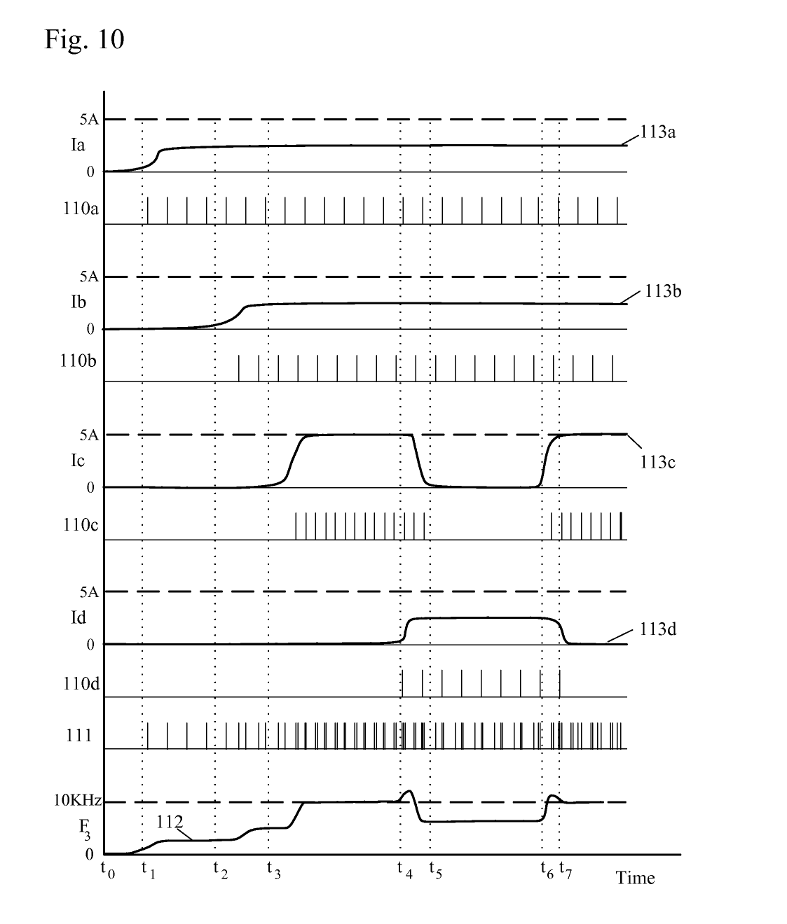

FIG. 10 shows a diagram to illustrate the operation of this embodiment in a system with four power units 4a-4d. In the graph of FIG. 10, the current Iₐ drawn from bus 2 by power unit 4a is represented by trace 113a, and the pulses output to monitor bus by power unit 4a are represented by line 110a. Similarly, the current I_{b} drawn from bus 2 by power unit 4b is represented by trace 113b with the output being pulse train 110b, and so on, through to power unit 4d. The combined pulse signal on monitor bus 3 is represented at 111, and the frequency on the monitor bus F₃ (i.e number of pulses per second), is represented by trace 112. Let us assume for this example that the current-to-frequency scaling in the power units is one ampere equals 1 KHz, so that when the maximum 10 amperes of current draw on bus 2 is reached, the pulse frequency F3 on monitor bus 3 is 10 kilohertz (KHz).

The operation of the system will now be described with reference to the time marks t₀-t₇ in FIG. 10:
t₀: none of the power units 4a-4d are drawing current from bus 2. There are no pulses on monitor bus 3, and accordingly F₃ 112 is zero.
t₁: A device drawing about 2.5 amperes is plugged into power unit 4a. The microcontroller 102 in power unit 4a detects that the pulse frequency F3 112 is not over 10 KHz (or some preselected value less than that), so its power converter 81 begins supplying power to the device. Its input current Iₐ 113a rises as current is drawn from bus 2, and power unit 4a begins outputting a pulse train 110a at a rate of 2.5 KHz. This is reflected by pulse train 111 on monitor bus 3, and the F₃ graph 112 rises to 2.5 KHz as well.
t₂: A device drawing about 2.5 amperes is plugged into power unit 4b. The microcontroller 102 in power unit 4b detects that the pulse frequency F3 112 is not over 10 KHz (or some preselected value less than that), so its power converter 81 begins supplying power to the device. Its input current I_{b} 113b rises as current is drawn from bus 2, and power unit 4b begins outputting a pulse train 110b at a rate of 2.5 KHz. This is reflected by an increase in pulses in pulse train 111 on monitor bus 3, and the F₃ graph 112 rises to 5 KHz.
t₃: A device drawing about 5.0 amperes is plugged into power unit 4c. The microcontroller 102 in power unit 4c detects that the pulse frequency F3 112 is not over 10 KHz (or some preselected value less than that), so its power converter 81 begins supplying power to the device. Its input current I_{c} 113c rises as current is drawn from bus 2, and power unit 4c begins outputting a pulse train 110c at a rate of 5.0 KHz. This is reflected by an increase in pulses in pulse train 111 on monitor bus 3, and the F₃ graph 112 rises to 10 KHz. This is the frequency which represents the maximum safe current draw from bus 2, so any additional current draw will result in an overload.
t₄: A device drawing about 2.5 amperes is plugged into power unit 4d. The microcontroller 102 in power unit 4d detects that the pulse frequency F3 112 is not over 10 KHz (in this example, we will assume that the power unit is programmed to consider only frequencies over 10 KHz as overload), so its power converter 81 begins supplying power to the device. Its input current I_{d} 113d rises as current is drawn from bus 2, and power unit 4d begins outputting a pulse train 110d at a rate of 2.5 KHz. This is reflected by an increase in pulses in pulse train 111 on monitor bus 3, and the F₃ graph 112 begins to rise above 10 KHz.
t₅: Power unit 4c is the first to detect that F₃ 112 has risen above the 10 KHz limit, and the microcontroller in the power unit 4c raises the inhibit line to the power converter in power unit 4c, causing the power converter to shut down. The current drawn by power unit 4c drops to zero, and power unit 4c stops outputting pulses onto monitor bus 3. Accordingly, the frequency F₃ 112 drops to 7.5 KHz, because there are three power units 4a, 4b and 4d, each putting 2.5 KHz worth of pulses on the bus. Since this is comfortably below the 10 KHz limit, the three remaining power units 4a, 4b and 4d all continue supplying current to their users.
t₆: After a delay, power unit 4c detects that the frequency F₃ 113 on monitor bus 3 is below the 10 KHz limit. Its power converter 81 begins supplying power to the device connected to the power unit 4c again. Its input current I_{c} 113c rises as current is drawn from bus 2, and power unit 4c begins outputting a pulse train 110d at a rate of 5.0 KHz. This is reflected by an increase in pulses in pulse train 111 on monitor bus 3, and the F₃ graph 112 begins to rise above 10 KHz.
t₇: This time, power unit 4d is the first to detect that F₃ 112 has risen above the 10 KHz limit, and the microcontroller in the power unit 4d raises the inhibit line to the power converter in power unit 4d, causing the power converter to shut down. The current drawn by power unit 4d drops to zero, and power unit 4d stops outputting pulses onto monitor bus 3. Accordingly, the frequency F₃ 112 drops to 10.0 KHz, because there are two power units 4a and 4b each putting 2.5 KHz worth of pulses on monitor bus 3, plus power unit 4c putting 5.0 KHz worth of pulses on the monitor bus 3. Since this is not above the 10 KHz limit, the three remaining power units 4a, 4b and 4c continue supplying current to their users.

The system continues on from that point, as loads are added to and removed from the bus 2.

### Embodiment 3

### Control by Digital Signals on Digital Monitor Bus

In another possible implementation, the analog share bus is implemented digitally by any one of a number of common communications buses, such as CAN bus or Ethernet. Each unit would report its load current, and each unit could then know all the currents. Any type of algorithm could be implemented to drop of users for load shedding. The first user to be dropped could be the user who has been on the longest time, the user who has consumed the least watt-hours, the user who has consumed the most watt-hours, etc.

### Tri-State Signal Interface

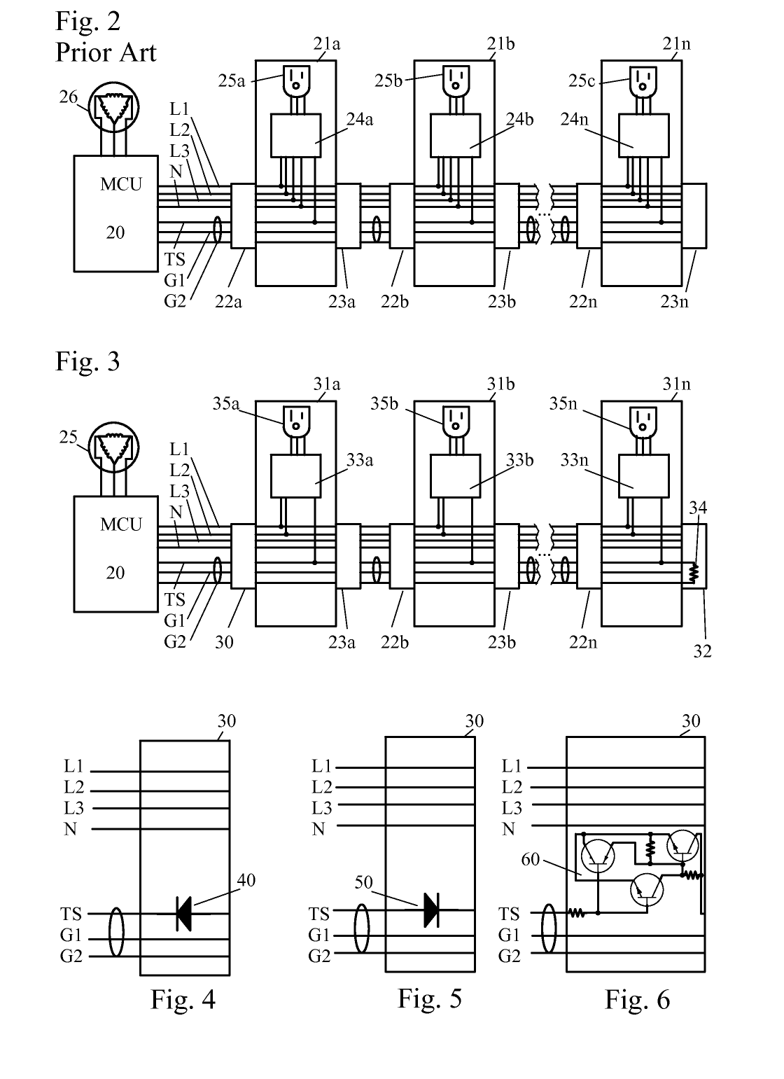

Legacy aircraft cabin power systems employ a centrally generated tri-state signal that is daisy chained between units. FIG. 2 shows a system of the prior art in such an arrangement. The legacy system has takes three-phase 400 Hz AC power from the aircraft generator 26, and routes the power from generator 26 through a Master Control Unit (MCU) 20 to a three-phase power bus with lines L1-L3 and N to a plurality of under-seat power units 21a-21n. There is also a tri-state control line TS with a safety ground G1 and a shield ground G2, which is used for tri-state control of the power units, as will be discussed below.

The power units 21a-21n are “daisy chained” —that is, each power unit 21a-21n has an input connector 22a-22n and an output connector 23a-23n, and the conductors L1-L3, N, TS, G1 and G2 pass through the power unit 21a-21n, with the power unit making internal connections to the bus conductors as they pass through the box. Each power unit 21a-21n has a power conversion module 24a-24n which takes the three-phase 400 Hz power from lines L1-L3 and converts it to 120VAC at 60 Hz (or whatever voltage and frequency are desired for the passenger devices) at the under-seat outlets 25a-25n. Tri-state control line TS is connected to the conversion module 24a-24n so that the MCU 20 can control the operation of the module.

The legacy systems used the TS line to control the power units 21a-21n by putting a tri-state signal on the TS line— “Tri-State” meaning that the line can be “low”, “high” or open. This allows the various power units 21a-21n to be commanded by the MCU 20 to operate in one of three modes— “Local Mode” where new users are permitted to connect to the bus (i.e. the power conversion module 24a-24n will provide power to the associated outlet 25a-25n), “Power Management Mode”, where new users are denied connection to the bus but existing users continue (i.e., if there is already a user who is pulling power from outlet 25a-25n, the power conversion module 24a-24n continues to supply power, but it will not start to supply power to a new user who was not already connected), and “Shut Down Mode” to shut down all of the outlets entirely (i.e. the power conversion unit 24a-24n stops supplying power to outlet 25a-25n).

While these are the usual modes which can be commanded by MCU 20 on the tri-state control line TS, the actual correspondence between the state and the mode may differ. The following table presents the different possibilities for the tri-state signal.

TABLE 1
Tri-state Signal Control Scenarios

| Commanded | Scenario | Scenario | Scenario | Scenario | Scenario | Scenario |
|---|---|---|---|---|---|---|
| Module Mode | 1A | 1B | 2A | 2B | 3A | 3B |
| Local Control | Open | Open | High | High | Low | Low |
| Power Management | High | Low | Open | Low | Open | High |
| Shut Down | Low | High | Low | Open | High | Open |

It is possible within the teachings of the invention to adapt the system of the invention to work in an aircraft cabin wired for a legacy power management system using tri-state control. In adapting the system of the invention to legacy systems with tri-state control, the adapted system is set up to reinterpret the existing tri-state signals, as follows.

TABLE 2
Interpretation of MCU Generated Tri-state Control Signals

| Control Mode | Legacy Operation | Present System Operation |
|---|---|---|
| Local Control | Normal operation - | Normal operation - allow new |
| | allow new users | users up to the point where |
| Power Management | Do not allow new | power management mode is |
| | users | entered as determined by the |
| | | power monitor bus. |
| Shut Down | Units shut down | Units shut down |

FIG. 3 shows a block diagram of the system of the invention, adapted to work with a legacy aircraft MCU 20 and daisy chain bus conductors L1-L3, N, TS, G1 and G2. Legacy elements in FIG. 3 are given the same reference numbers as in FIG. 2, while new elements are given new numbers.

In this adapted system, power units 31a-31n are constructed and operate as described in the above sections. They are plugged into the input connectors 22b-22n and output connectors 23a-23(n−1). The first input connector 22a connecting to the first power unit in the chain 21a is replaced by a head end connector 30, which adapts the TS control line and will be described in detail below. As the power conversion stages 33a-33n in power units 31a-31n are taken to be single-phase stages, the power conversion stages 33a-33n are connected to only two of the three three-phase conductors L1 and L2. L3 and N are not used. It will be understood, though, that three-phase power conversion stages could be used as in the prior art systems within the teaching of the invention. The output of power conversion stages 33a-33n powers outlets 35a-35n, under the control of the control circuit and method described above.

The last output connector 23n connector on the last power unit in the chain 21n is replaced by a back end connector 32. The back end connector 32 has a terminating resistor 34 connecting conductor TS to ground, which operates as the reference resistor 7 from FIG. 1. Thus, conductor TS becomes the monitor bus 3 from FIG. 1.

Because conductor TS is used as the monitor bus 3, it must be isolated from the tri-stage control signals from MCU 20 during normal operation. This isolation is done in the head end connector 30, and the different scenarios from table 1, above, require different embodiments of the head end connector 30. These embodiments are shown in FIGS. 4-6.

### Scenario 1A

### “Normal Operation” is Denoted by Either “High” or “Open” Tri-State Signal, Shut Down on “Low” Tri-State Signal

This scenario uses the head end connector 30 shown in FIG. 4. This has a diode 40 implemented in it so as to isolate the power management bus TS from a “high” tri-state signal. Thus, a “high” power management command from the MCU 20 is ignored, and the power units 33a-33n manage power normally, according to the method described above. Similarly, an “open” signal on the power management bus TS allows TS to operated as monitor bus 3.

A “low” signal on the power management bus TS will pull the monitor bus 3 to zero volts plus a diode drop, and circuitry internal to the power units 33a-33n will detect this and force the power units to shut down.

### Scenario 1B

### “Normal Operation” is Denoted by Either “Low” or “Open” Tri-State Signal, Shut Down on “High” Tri-State Signal

This scenario uses the head end connector 30 shown in FIG. 5. This has a diode 50 implemented in it, reversed in polarity from diode 40 of FIG. 4, so as to isolate the power management bus TS from a “low” tri-state signal. Thus, a “low” power management command from the MCU 20 is ignored, and the power units 33a-33n manage power normally, according to the method described above. Similarly, an “open” signal on the power management bus TS allows TS to operated as monitor bus 3.

If the tri-state signal on TS is set “high”, this will force a high voltage on monitor bus 3, and circuitry internal to the power units 33a-33n will detect this and force the power units to shut down.

### Scenario 2A

### “Normal Operation” Denoted by a “Open” or “High” Tri-State Signal, Shut Down on “Low” Tri-State Signal

This is the same situation as scenario 1A, except that the functions of “high” and “open” are reversed by the MCU 20 for operating the legacy system in local control and power management mode. Since the power units 33a-33n of the invention treat both “local control” and “power management” the same—i.e., normal operation—the adapted system of the invention is the same here as in scenario 1A, the head end connector 30 using the diode 40 arrangement in FIG. 4.

### Scenario 2B

### “Normal Operation” Denoted by a “High” or “Low” Tri-State Signal, Shut Down on “Open” Tri-State Signal

This scenario uses the head end connector 30 as shown in FIG. 6, which has a circuit 60 implemented in it so as to isolate the power management bus TS from either a “high” or “low” tri-state signal. Thus, a “low” or “high” power management command from the MCU 20 is ignored, and the power units 33a-33n manage power normally, according to the method described above.

An “open” signal from the tri-state power management bus TS will force the head end connector 30 circuit 60 to pull the power management bus TS below 1V and thereby force all power units 33a-33n to shut down.

### Scenario 3A

### “Normal Operation” Denoted by a “Low” or “Open” Tri-State Signal, Shut Down on “High” Tri-Stage Signal

This is the same situation as scenario 1B, except that the functions of “low” and “open” are reversed by the MCU 20 for operating the legacy system in local control and power management mode. Since the power units 33a-33n of the invention treat both “local control” and “power management” the same—i.e., normal operation—the adapted system of the invention is the same here as in scenario 1B, the head end connector 30 using the diode 50 arrangement in FIG. 5.

### Scenario 3B

### “Normal Operation” Denoted by a “Low” or “High” Tri-State Signal, Shut Down on “Open” Tri-State Signal

This is the same situation as scenario 2B, except that the functions of “low” and “high” are reversed by the MCU 20 for operating the legacy system in local control and power management mode. Since the power units 33a-33n of the invention treat both “local control” and “power management” the same—i.e., normal operation—the adapted system of the invention is the same here as in scenario 2B, the head end connector 30 using the circuit 60 arrangement in FIG. 6.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A load distribution system and power management system for distributing electrical power from a power source having a maximum current draw to a plurality of user devices, comprising:
a) a power bus coupled to the power source;
b) a monitor bus;
c) a plurality of power units coupled to the power bus and the monitor bus, each power unit comprising:
i) a power conversion stage having an input coupled to the power bus, an inhibit input and an output for connection of a user device;
ii) a current sensor sensing current drawn from the power bus by a user device connected to the output of the power conversion stage;
iii) a power sense circuit having an input coupled to the current sensor, and an output coupled to the monitor bus, the power sense circuit putting a signal on the monitor bus proportional to the current sensed by the current sensor, such that the total signal on the monitor bus is proportional to the total current being drawn from the power bus by the power conversion stages of the plurality of power units; and
iv) a comparator having an input coupled to the monitor bus for comparing the total signal on the monitor bus to a reference, and an output coupled to the inhibit input of the power conversion stage;
such that when the total signal on the monitor bus rises to a selected value relative to the reference, the comparator output causes a signal on the inhibit input of the power conversion stage, thus causing the power to the user device to be disconnected; and
the reference being chosen such that when the total signal on the monitor bus reaches the reference, the power conversion units in the plurality of power units are drawing the maximum current draw from the power source on the power bus.

2. The load distribution system and power management system of claim 1, in which:
the signal put on the monitor bus by each power unit is a current proportional to the current drawn from the power bus by the power unit;
the monitor bus has a reference resistor creating a voltage on the monitor bus proportional to current on the monitor bus;
the reference is a voltage; and
the comparator is a voltage comparator.

3. The load distribution system and power management system of claim 1, in which:
the signal put on the monitor bus by each power unit is a train of pulses having a frequency proportional to the current drawn from the power bus by the power unit, such that the monitor bus has a signal representing a total of the trains of pulses from each power unit, thus having a frequency proportional to total current drawn by the power units from the power bus; and
the reference is a frequency.

4. The load distribution system and power management system of claim 1, in which the output of the comparator is coupled to the inhibit input of the power conversion stage through at least one timer, such that the signal on the inhibit input of the power conversion stage is delayed.

5. The load distribution system and power management system of claim 4, in which the output of the comparator is coupled to the inhibit input of the power conversion stage through a plurality of timers coupled together by an OR-gate, such that the signal on the inhibit input of the power conversion stage is delayed by an amount measured by the shortest of the plurality of timers.

6. The load distribution system and power management system of claim 5, in which at least one of the timers is a random time delay.

7. The load distribution system and power management system of claim 1 in which the power source further comprises a master control unit having a tri-state output coupled to the monitor bus through a head end connector.

8. The load distribution system and power management system of claim 7 in which the tri-state output of the master control unit comprises a tri-state signal representing three operating modes, one of the operating modes being shut down, and the head end connector comprises a circuit for converting the tri-state signal such that the power units disconnect power from the user devices when the tri-state signal is in the mode representing a shut down.

9. A power unit for a load distribution and power management system for distributing electrical power from a power source having a maximum current draw to a plurality of user devices, the system comprising a power bus coupled to the power source and a monitor bus; the power unit comprising:
a) a power conversion stage having an input coupled to the power bus, an inhibit input and an output for connection of a user device;
b) a current sensor sensing current drawn from the power bus by a user device connected to the output of the power conversion stage;
c) a power sense circuit having an input coupled to the current sensor, and an output coupled to the monitor bus, the power sense circuit putting a signal on the monitor bus proportional to the current sensed by the current sensor, such that the total signal on the monitor bus is proportional to the total current being drawn from the power bus by the power conversion stages of the plurality of power units; and
d) a comparator having an input coupled to the monitor bus for comparing the total signal on the monitor bus to a reference, and an output coupled to the inhibit input of the power conversion stage;
such that when the total signal on the monitor bus rises to a selected value relative to the reference, the comparator output causes a signal on the inhibit input of the power conversion stage, thus causing the power to the user device to be disconnected; and
the reference being chosen such that when the total signal on the monitor bus reaches the reference, the power conversion units in the plurality of power units are drawing the maximum current draw from the power source on the power bus.

10. The power unit of claim 9, in which:
the signal put on the monitor bus by each power unit is a current proportional to the current drawn from the power bus by the power unit;
the monitor bus has a reference resistor creating a voltage on the monitor bus proportional to current on the monitor bus;
the reference is a voltage; and
the comparator is a voltage comparator.

11. The power unit of claim 9, in which:
the signal put on the monitor bus by each power unit is a train of pulses having a frequency proportional to the current drawn from the power bus by the power unit, such that the monitor bus has a signal representing a total of the trains of pulses from each power unit, thus having a frequency proportional to total current drawn by the power units from the power bus; and
the reference is a frequency.

12. The power unit of claim 9, in which the output of the comparator is coupled to the inhibit input of the power conversion stage through at least one timer, such that the signal on the inhibit input of the power conversion stage is delayed.

13. The power unit of claim 12, in which the output of the comparator is coupled to the inhibit input of the power conversion stage through a plurality of timers coupled together by an OR-gate, such that the signal on the inhibit input of the power conversion stage is delayed by an amount measured by the shortest of the plurality of timers.

14. The power unit of claim 13, in which at least one of the timers is a random time delay.

15. A method of operating a load distribution and power management system for distributing electrical power from a power source having a maximum current draw to a plurality of user devices, the system comprising a power bus coupled to the power source; a monitor bus; and a plurality of power units coupled to the power bus and the monitor bus, each power unit comprising a power conversion stage having an input coupled to the power bus and an output for connection of a user device, each power unit putting a signal on the monitor bus proportional to current drawn from the power bus by a user device on the output of the power conversion stage of the power unit; a selected total signal on the monitor bus indicating the point at which the power conversion units in the plurality of power units are drawing the maximum current draw from the power source on the power bus, wherein the method comprises:
a) when a user connects a user device to the output of the power conversion stage of a power unit, the power unit supplying power from the power bus to the user device;
b) the power unit sensing the signal on the monitor bus after supplying power to the user device; and
c) if, after the power unit supplies power to the user device, the signal on the monitor bus is greater than a value related to the selected monitor bus reference, the power unit disconnecting power to the user device.

16. The method of claim 15, in which step (a) further comprises, before the power unit supplies power to the user device, the power unit sensing the signal on the monitor bus and if the signal on the monitor bus is greater than a value related to the selected monitor bus reference, the power unit does not supply power to the user device.

17. The method of claim 16, in which the value related to the selected monitor bus reference is the selected monitor bus reference less a headroom amount representing a typical current draw for a user device, such that the power unit will only supply power to the user device if it is likely that the addition of a typical user device would not exceed the maximum draw from the power source.

18. The method of claim 16, in which if the power unit does not supply power to the user device, the method further comprises waiting for a time delay, then the power unit repeating step (a).

19. The method of claim 15, in which, in step (c), the value related to the selected monitor bus reference is the selected monitor bus reference less a headroom amount.

20. The method of claim 15 in which the comparison in step (c) is performed after a delay.

21. The method of claim 20, in which the time delay is randomized.

22. The method of claim 15, in which the method repeats step (c) as long as the power unit is supplying power to a user device.

23. The method of claim 15, in which the signal put on the monitor bus by each power unit is a current proportional to the current drawn from the power bus by the power unit; the monitor bus has a reference resistor creating a voltage on the monitor bus proportional to current on the monitor bus; the reference is a voltage; the comparator is a voltage comparator; and the selected monitor bus reference in each power unit is varied based on a non-synchronized ramp voltage, such that which power unit disconnects its user device when the selected monitor bus reference is reached is randomized between power units.

24. The method of claim 15, in which at least one of the power units has a different value related to the selected monitor bus reference relative to other power units, such that the at least one power unit is given priority for power.

25. The method of claim 15, in which the signal put on the monitor bus by each power unit is a train of pulses having a frequency proportional to the current drawn from the power bus by the power unit, such that the monitor bus has a signal representing a total of the trains of pulses from each power unit, thus having a frequency proportional to total current drawn by the power units from the power bus; and the reference is a frequency.
